(19) United States
(12) Patent Application Publication
(10) Pub. No.: US 2020/0014854 A1
(43) Pub. Date: Jan. 9, 2020

(54) FACTORY DATA MANAGEMENT METHOD AND SYSTEM

(71) Applicant: HITACHI, LTD., TOKYO (JP)

(72) Inventor: Satoshi KATSUNUMA, Santa Clara, CA (US)

(21) Appl. No.: 16/030,555

(22) Filed: Jul. 9, 2018

(51) Int. Cl. H04N 5/232; G05B 19/418

(52) U.S. Cl. CPC H04N 5/23299; H04N 5/23206; G05B 19/4183; H04N 5/23296; H04N 5/23218

(57) ABSTRACT

Systems and methods as described herein are directed to the management of a camera system that can involve Pan/Tilt/Zoom (PTZ) cameras and fixed cameras. The fixed cameras are provided with digital PTZ, capabilities through trimming positions and translation matrixes. Through an interface, users can associate different PTZ configurations for a target factory asset in response to an incident or other operation occurring at the asset. When the incident or operation occurs with the target asset, the video and configuration from the corresponding camera can be immediately provided in response.

### BACKGROUND

### Field

The present disclosure is related to factory asset management, and more specifically, to management of factory asset data through the use of cameras.

### Related Art

In factories, there can be many types of assets that may need to be monitored remotely through the use of cameras, particularly when some incident occurs in the asset (e.g., malfunction, accident, etc.). For occurring incidents, it can be important to provide video from the camera corresponding to the asset in which some incident has occurred.

In a related art implementation, there are systems and methods for overlaying camera video views within a scene model. In such a related art implementation, users select the view point, and then the related art system selects cameras based on the view point and the geometric locations of the cameras. The related art system then calculates the distance between the selected view point and the cameras and selects the nearest camera. In addition, for PTZ (Pan/Tilt/Zoom) cameras, the related art system can calculate the distance to the view point from each PTZ camera based on the coordinates of the camera and use the nearest PTZ camera.

### SUMMARY

In the related art implementation, such techniques are not applicable to the monitoring of factory assets because of the various requirements for monitoring such assets. In factories, operators have a need to monitor at different scales (e.g., from a wide area to specific details of the factory asset). Operators also have a need to monitor assets in different angles according to direction of the asset. Moreover, how assets are monitored may need to be changed depending on the type of incident, even if such incidents occur in the same asset. Therefore, it is difficult to provide videos from cameras based only on the location of the asset.

To address the above issues the present disclosure involves a method for providing video of a target asset in response to an operation, the method involving receiving a selection of one or more cameras from a plurality of cameras for the target asset from a plurality of assets, the target asset selected from a logical hierarchy arrangement of the plurality of assets, the selection of the one or more cameras based on a physical location of the one or more cameras and a physical location of the target asset; for each of the selected one or more cameras, receiving a configuration of camera scale and camera angle for the target asset from the plurality of assets and the operation; associating the configuration for the each of the selected one or more cameras with the target asset and the operation; and for the occurrence of the operation for the target asset, delivering the video for the target asset in response to the operation through configuring a camera from the selected one or more cameras according to the associated configuration.

Aspects of the present disclosure further involve a non-transitory computer readable medium, storing instructions for providing video of a target asset in response to an operation, the instructions involving receiving a selection of one or more cameras from a plurality of cameras for the target asset from a plurality of assets, the target asset selected from a logical hierarchy arrangement of the plurality of assets, the selection of the one or more cameras based on a physical location of the one or more cameras and a physical location of the target asset; for each of the selected one or more cameras, receiving a configuration of camera scale and camera angle for the target asset from the plurality of assets and the operation; associating the configuration for the each of the selected one or more cameras with the target asset and the operation; and for the occurrence of the operation for the target asset, delivering the video for the target asset in response to the operation through configuring a camera from the selected one or more cameras according to the associated configuration.

Aspects of the present disclosure further involve a system for providing video of a target asset in response to an operation, the system involving means for receiving a selection of one or more cameras from a plurality of cameras for the target asset from a plurality of assets, the target asset selected from a logical hierarchy arrangement of the plurality of assets, the selection of the one or more cameras based on a physical location of the one or more cameras and a physical location of the target asset; for each of the selected one or more cameras, means for receiving a configuration of camera scale and camera angle for the target asset from the plurality of assets and the operation; means for associating the configuration for the each of the selected one or more cameras with the target asset and the operation; and for the occurrence of the operation for the target asset, means for delivering the video for the target asset in response to the operation through configuring a camera from the selected one or more cameras according to the associated configuration.

Aspects of the present disclosure further include a system for providing video of a target asset in response to an operation, the system involving a plurality of cameras; and a processor, configured to receive a selection of one or more cameras from the plurality of cameras for a target asset from a plurality of assets, the target asset selected from a logical hierarchy arrangement of the plurality of assets, the selection of the one or more cameras based on a physical location of the one or more cameras and a physical location of the target asset; for each of the selected one or more cameras, receive a configuration of camera scale and camera angle for the target asset from the plurality of assets and the operation; associate the configuration for the each of the selected one or more cameras with the target asset and the operation; and for an occurrence of the operation for the target asset, deliver the video for the target asset in response to the operation through configuring a camera from the selected one or more cameras according to the associated configuration.

### BRIEF DESCRIPTION OF DRAWINGS

FIG. 1 illustrates a physical configuration of the system, in accordance with an example implementation.

FIG. 2 illustrates an example system configuration according to an example implementation.

FIG. 3 illustrates an asset definition table, in accordance with an example implementation.

FIG. 4 illustrates an incident table, in accordance with an example implementation.

FIG. 5 illustrates a camera definition table, in accordance with an example implementation.

FIG. 6 illustrates an asset and camera relation table, in accordance with an example implementation.

FIG. 7 illustrates an example of the incident viewer, in accordance with an example implementation.

FIG. 8 illustrates an example of the asset video viewer, in accordance with an example implementation.

FIGS. 9(a) and 9(b) illustrate an example flow diagram of the camera linking module, in accordance with an example implementation.

FIG. 10 illustrates an example flow diagram for a camera video delivery module, in accordance with an example implementation.

FIG. 11 illustrates another example system configuration, in accordance with an example implementation.

FIG. 12 illustrates a priority-based asset and camera relation table, in accordance with an example implementation.

FIG. 13 illustrates a camera status management table, in accordance with an example implementation.

FIG. 14 illustrates an example flow chart for the camera video priority-based delivery module, in accordance with an example implementation.

FIG. 15 illustrates a flow chart for the camera selection operation of the camera video priority-based delivery module, in accordance with an example implementation.

FIG. 16 illustrates an example system configuration in accordance with an example implementation.

FIG. 17 illustrates an asset registration viewer, in accordance with an example implementation.

FIG. 18 illustrates an example computing environment with an example computer device suitable for use in some example implementations.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

### First Example Implementation

In a first example implementation, systems and methods described herein deliver the videos of some assets that are linked to fixed cameras, and PTZ cameras. Operators select cameras and control the PTZ cameras by providing incident information, the target assets, the logical hierarchy of assets, and the physical locations of assets and cameras. Depending on how the operators wish to view the assets, the first example implementation additionally links the assets and such operations (e.g., addressing incidents) to fixed cameras and the PTZ cameras.

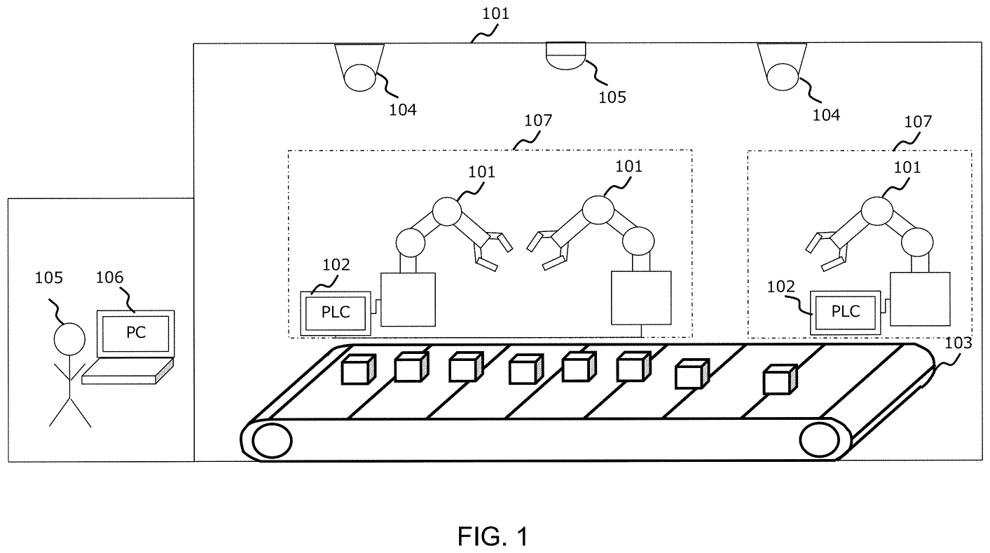

FIG. 1 illustrates a physical configuration of the system, in accordance with an example implementation. In a factory shop floor 101 as illustrated in FIG. 1, there can be many different types of factory assets such as lines 103, PLCs (Programmable Logic Controllers) 102 and machines 101. As illustrated in FIG. 1, the floor 101 may utilize lines 103, wherein the lines 103 are associated with PLCs 102. PLCs 102 may also be connected to machines 101 to control the operation of the machines 101. Each set of machines 101 that are controlled by one corresponding PLC 102 are grouped together as a PLC unit 107.

As illustrated in FIG. 1, the factory shop floor 101 may involve a camera system that can include fixed cameras 105 and PTZ cameras 104. PTZ cameras 104 are configured to be remotely controlled through a network by computing machines. In contrast, fixed cameras 105 are fixed and cannot be controlled. However, in example implementations described herein, by conducting digital processing of camera images from the fixed cameras 105 (e.g., trimming, extension/reduction, affine translation), the camera images can be changed remotely. The digital processing of camera images is referred herein as digital PTZ. Examples of fixed cameras 105 can include fish-eye cameras configured to monitor a 360 degree area around the camera.

The cameras 104 and 105 monitor factory assets such as floor 101, PLC units 107, and machines 101. Operators 105 can confirm the behavior of the factory assets remotely by utilizing a computer 106 or other device such as televisions, mobile devices, laptops, and so on.

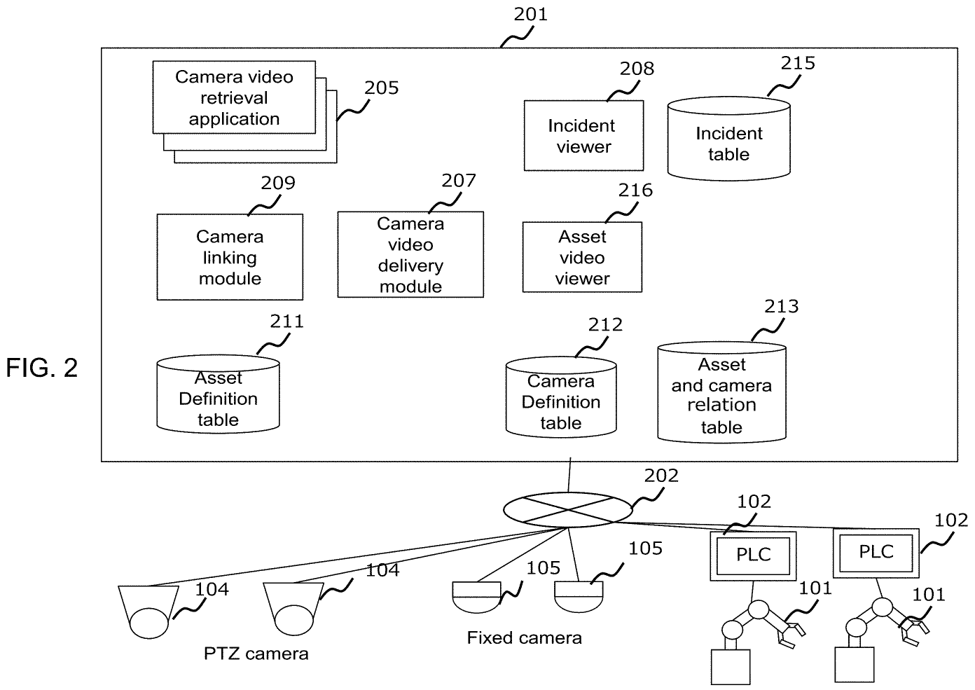

FIG. 2 illustrates an example system configuration according to an example implementation. The factory management computer 201 is connected to PLCs 102 and cameras such as fixed cameras 105 and PTZ cameras 104. The factory management computer 201 is generally installed in the factory, but the location of the installation can be anywhere according to the desired implementation. For example, factory management computer 201 can be located in-house data centers, public cloud systems, or other places. The factory management computer 201, PLCs 102 and cameras 104, 105 can be interconnected by in-factory network 202, but the present disclosure is not limited thereto, and other methods such as an in-house network or a secure network over the internet may also be utilized in accordance with the desired implementation. The PLCs 102 are also connected to machines 101 by using a dedicated control network.

In example implementations, the factory management computer 201 can involve a camera video delivery module 207, camera linking module 209, incident viewer 208, asset video viewer 216, asset definition table 211, incident table 215, camera definition table 212, asset and camera relation table 213, and camera video retrieval applications 205. Camera video retrieval application 205 is configured to send a camera video subscription request to the camera video subscription module 206, send the delivery request to the camera video delivery module 207, and receives camera images from the module 207. The camera video retrieval application 205 can be configured to show/store/analyze camera videos for monitoring, anomaly detection and management, or traceability management in factories.

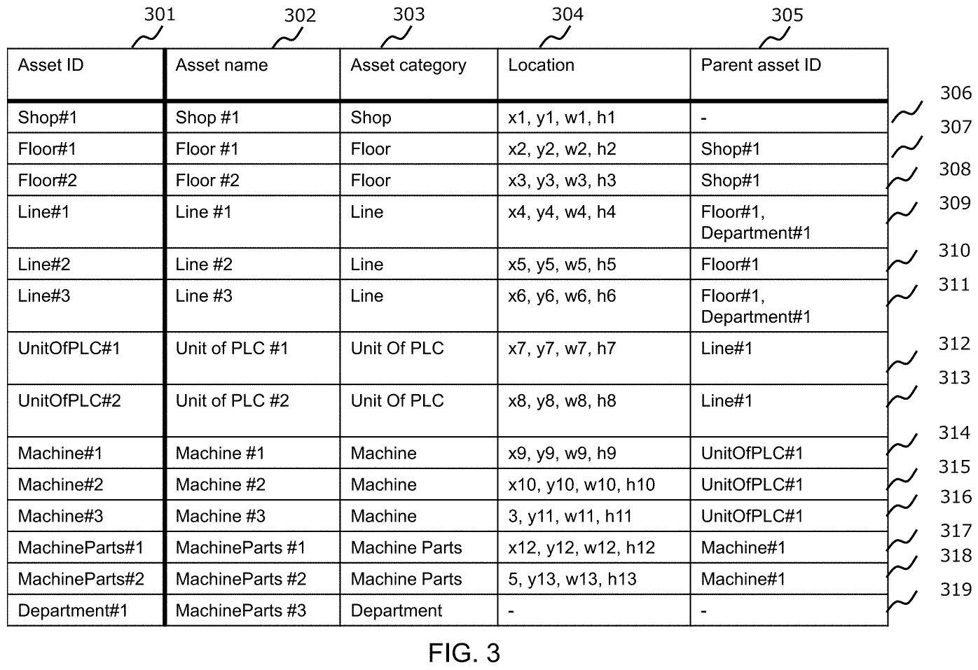

FIG. 3 illustrates an asset definition table 211, in accordance with an example implementation. The asset definition table 211 stores information regarding the factory assets. Such data can be stored in advance through any method according to the desired implementation. The asset definition table 211 has the columns for asset identifier (ID) 301, asset name 302, asset category 303, location 304, and parent asset ID 305. Asset ID 301 indicates the identifier for the factory assets. Asset name 302 indicates the name of the factory assets. Asset category 303 indicates the logical category or type of factory assets (e.g., shops, floors, lines, PLC units, machines, etc.) Asset location 304 indicates the physical location of the factory assets, which can include information such as the X-coordinate, Y-coordinate, width, and height on the factory floor map. For example in the entry of row 306, asset location is indicated as x1 (X-coordinate), y1 (Y-coordinate), w1 (Width), and h1 (Height).

Asset parent ID 305 shows the Asset ID of the parent asset to indicate the hierarchy of the factory assets. The factory assets are defined as logical hierarchy tree and each node (asset) in the tree is linked by the asset parent ID 305. In addition, the layers of the tree are defined by the asset category 303.

Entries 306-319 illustrate example entries for the managed factory assets. For example, Asset 307 is directed to the asset ‘Floor#1’, which is a floor type of asset located at x2, y2, w2, h2, and under the asset ID Shop#1′ in the asset hierarchy.

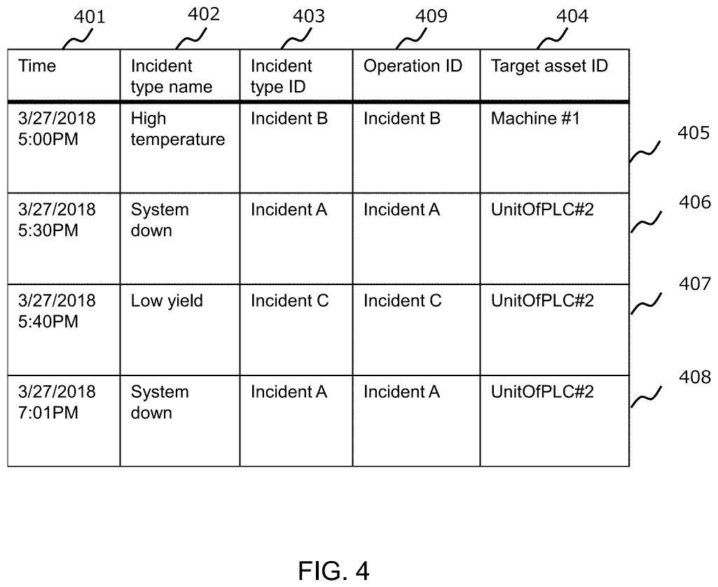

FIG. 4 illustrates an incident table 215, in accordance with an example implementation. The incident table 215 stores incident information, which includes data regarding the occurrence of any incident (e.g., PLC sends alerts regarding machines). The incident table has columns for time 401, incident type name 402, incident type ID 403, operation ID 409, and target asset ID 404. Time 401 indicates a timestamp for when an incident occurred. Incident type name 402 indicates the type of incident that occurred. Type id 403 indicates the ID of the type of incident. Operation ID 409 indicates the ID of the operation related to the type of incident. Target asset ID 404 indicates the ID of the asset related to the incident.

Entries 405-408 indicate entries for incidents that have occurred. For example, Entry 405 indicates that an incident occurred on Mar. 27, 2018 at 5:00 PM, having an incident type of ‘High Temperature’, an incident type ID of ‘Incident B’, an operation ID of ‘Incident B’, and the asset ID affected is ‘Machine#1’.

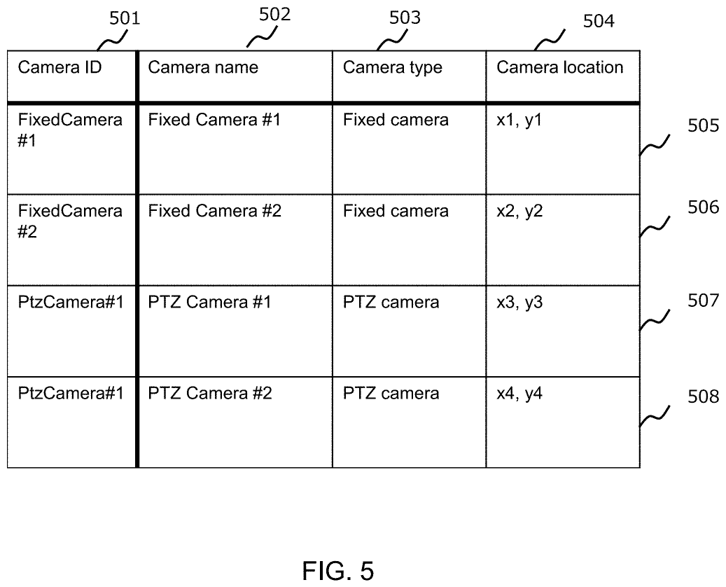

FIG. 5 illustrates a camera definition table 212, in accordance with an example implementation. The camera definition table 212 stores the information regarding the managed cameras, which can be stored in advance by any method according to the desired implementation.

The camera definition table has columns for the camera ID 501, camera name 502, camera type 503, and camera position 504. Camera ID 501 indicates the ID of the camera. Camera name 502 indicates the name of the camera. Camera type 503 indicates the type of camera (e.g., fixed camera, PTZ camera). Camera position 504 indicates the location of the camera (e.g., X-coordinate, Y-coordinate) on the factory floor map. In an example entry 505, the camera location is designated as x1 (X-coordinate), y1 (Y-coordinate).

Entries 505-508 indicate entries for the cameras that are managed. For example, entry 506 indicates a camera having the camera ID of ‘FixedCamera#2’, the camera name is set as ‘Fixed Camera #2’, the type of camera is a fixed camera, and the camera location is x2, y2.

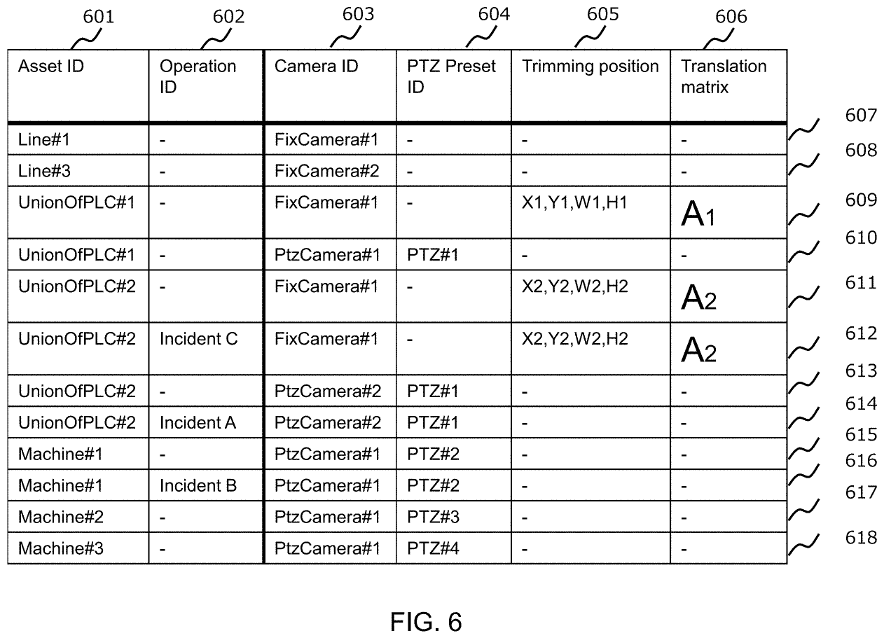

FIG. 6 illustrates an asset and camera relation table 213, in accordance with an example implementation. The asset and camera relation table 213 stores the information regarding the relationship between assets/operations and cameras, as well as PTZ information as applicable (e.g., PTZs, trimming positions, and translation matrixes). The data is stored when the relation is added through the camera linking module 209. The asset and camera relation table 213 has columns for the asset ID 601, operation ID 602, camera ID 603, PTZ preset ID 604, trimming position 605, and translation matrix 606.

Asset ID 601 indicates the ID of the asset. Operation ID 602 indicates the ID for the type of operation made to the asset. Camera id 603 indicates the ID of the camera. PTZ preset ID 604 indicates the ID of the camera preset. Trimming position 605 indicates the trimming-target position on the video image of the camera. The translation matrix 606 shows the matrix for executing an affine translation on the video image of the camera. The asset ID 601 and the operation ID 602 are linked to the camera ID 603, the PTZ preset ID 604, the trimming position 605, and the translation matrix 606.

Entries 607-618 indicate example entries of assets as related to cameras. For example, entry 609 indicates an asset having an asset ID of ‘UnionOfPLC#1’ corresponds to camera ID ‘FixCamera#1’ having a trimming position of X1,Y1,W1,H1 and a translation matrix of A₁.

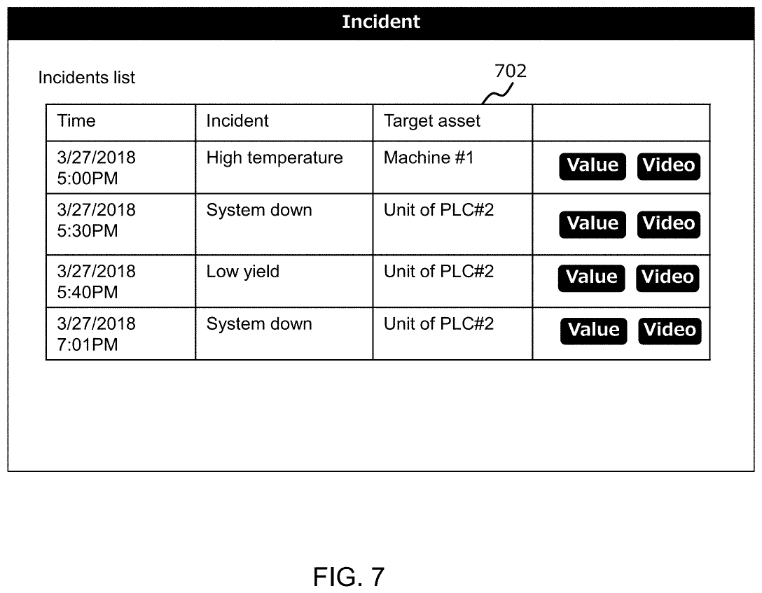

FIG. 7 illustrates an example of the incident viewer, in accordance with an example implementation. Specifically, FIG. 7 illustrates an incident viewer 208, which is an interface configured to provide information regarding recently occurring incidents through the presentation of information from FIG. 4. The incident viewer 208 provides an incidents list 702, which include information regarding the time, incident, and target asset from the incident table 215 as illustrated from FIG. 4. For example, the information for time is presented from time 401 from FIG. 4. The information for incident is taken from incident type name 402. The information for target asset is taken from target asset ID 404. Such incident information is loaded from incident table 215 in real time, and is configured with an interface with buttons for “Value” and Video”.

When operators click on the “Video” button, the viewer jumps to an asset video viewer and the operators can confirm the camera video linked to the corresponding incident, which is linked to the operation in the asset video viewer 216. When operators on the “Value” button, other values related to the incident (e.g., corresponding PLC information) can be provided.

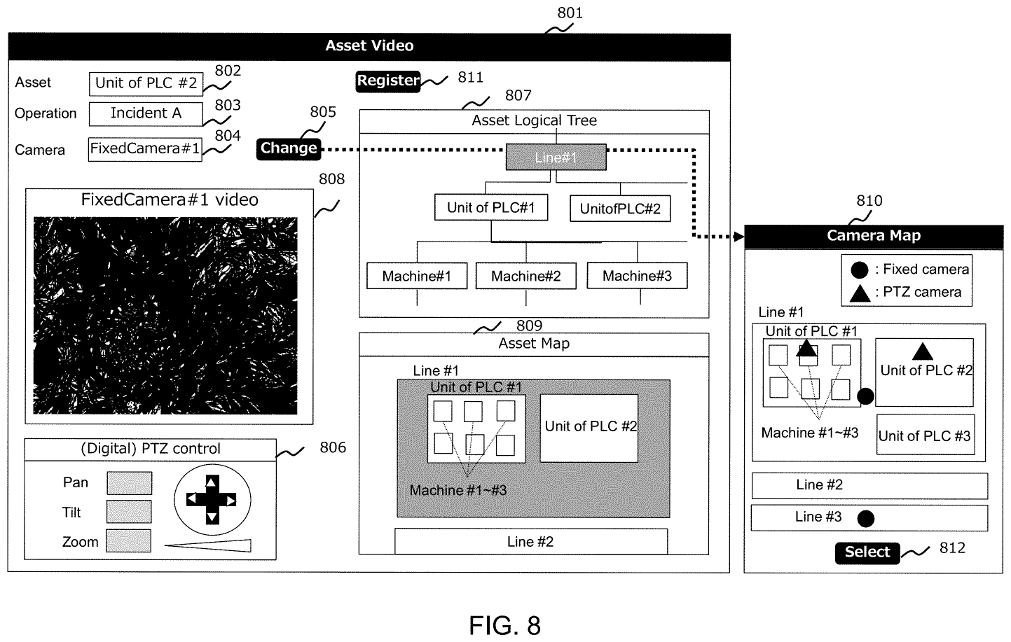

FIG. 8 illustrates an example of the asset video viewer 216, in accordance with an example implementation. In FIG. 8, the viewer 801 shows camera videos 808 corresponding to assets 802 and operations 803. The viewer 801 shows asset logical tree 807 and asset map 809. The asset logical tree 807 shows the logical relation of the assets, which is derived from the asset definition table 211 (e.g., from asset category 303 and parent asset ID 305). The asset map 809 indicates the location of each asset on the factory map, which is made from the asset definition table 211 (e.g., from location 304).

In example implementations, the operator can select assets on the asset logical tree 807 and asset map 809, and then the videos corresponding to the selected assets are provided in camera videos 808. The viewer 801 shows camera map 810, which shows the location of each camera on the factory map. Camera map 810 is made from camera definition table 212 (e.g., from camera position 504). The operator can select a camera on the camera map 810 through the select button 812, and then the camera video is provided in camera videos 808 and indicated on camera 804.

In example implementations, PTZ control 806 provides physical PTZ functionality for PTZ cameras, and/or digital PTZ control with fixed cameras. When operators click the “Register” button 811, a relationship between the selected assets 802, the operations 803, assets and these operations to camera and the (digital) PTZ setting is registered. Therefore, operators can monitor the camera video as soon as the incident happens and the incident viewer from FIG. 7 jumps to the viewer 801 of FIG. 8.

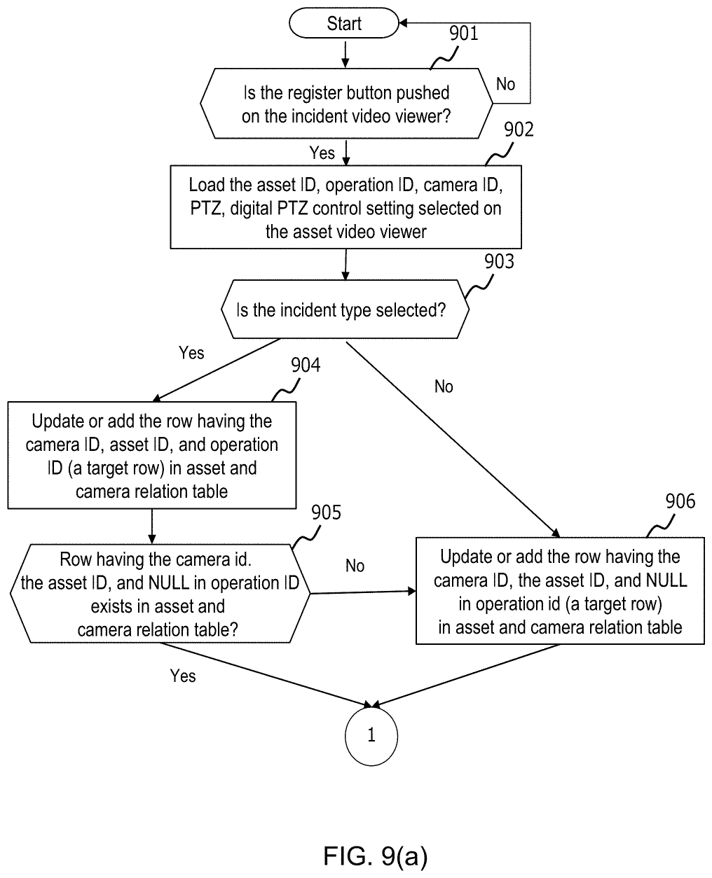

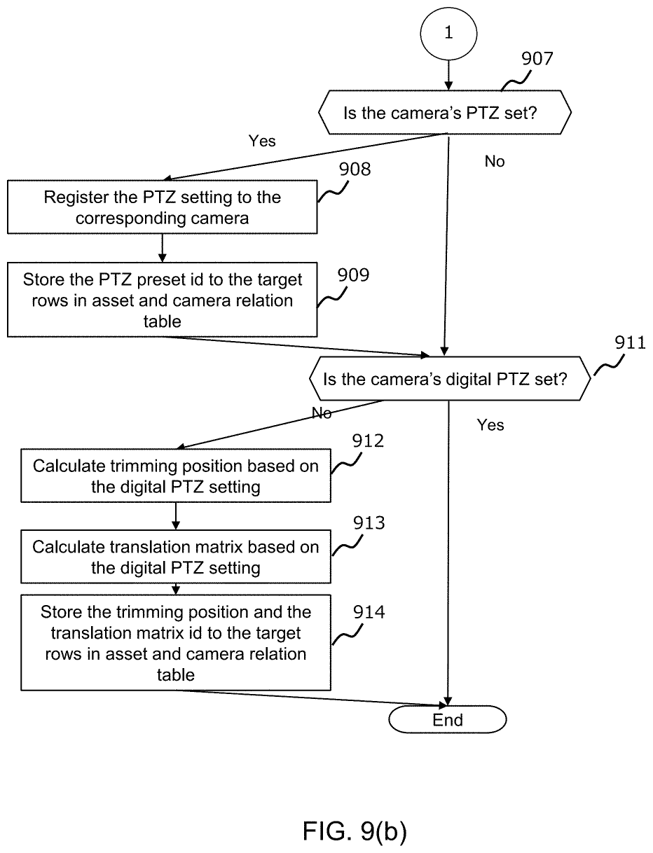

FIGS. 9(a) and 9(b) illustrate an example flow diagram of the camera linking module 209, in accordance with an example implementation. Specifically, FIGS. 9(a) and 9(b) illustrate an example flow diagram of a camera linking module 209 for additionally linking assets and these operations to cameras and PTZs according to registration information in the asset video viewer 216.

At 901, the module 209 judges whether the register button 811 is pushed/selected on the asset video viewer 216. At 902, the module 209 loads the asset ID, operation ID, camera ID, PTZ, and digital PTZ control setting selected on the asset video viewer 216. At 903, the module 209 determines whether the incident type (operation ID) is selected. If so (Yes) then the flow proceeds to 904, otherwise (No), the flow proceeds to 906.

At 904, the module 209 updates or adds the row having the camera ID, the asset ID, and the operation ID (referred to as a target row) in asset and camera relation table 213. At 905, the module 209 determines whether the row having the camera ID, the asset ID, and NULL in the operation ID exists in the asset and camera relation table 213. If so (Yes) then the flow proceeds to 907, otherwise (No) the flow proceeds to 906.

At 906, the module 209 updates or adds the row having the camera ID, the asset ID, and NULL in operation ID (target row) in asset and camera relation table 213. At 907, the module 209 determines whether the PTZ of the camera is set. If so (Yes), then the flow proceeds to 908, otherwise (No) the flow proceeds to 911. At 908, the module 209 registers the PTZ setting to the corresponding camera. At 909, the module 209 stores the PTZ preset ID to the target rows in asset and camera relation table 213.

At 911, the module 209 determines whether the digital PTZ of the camera is set. If so (Yes), then the flow ends, otherwise (No), the flow proceeds to 912. At 912, the module 209 calculates the trimming position based on the digital PTZ setting. At 913, the module 209 calculates the translation matrix based on the digital PTZ setting. At 914, the module 209 stores the trimming position and the translation matrix ID to the target rows in asset and camera relation table 213.

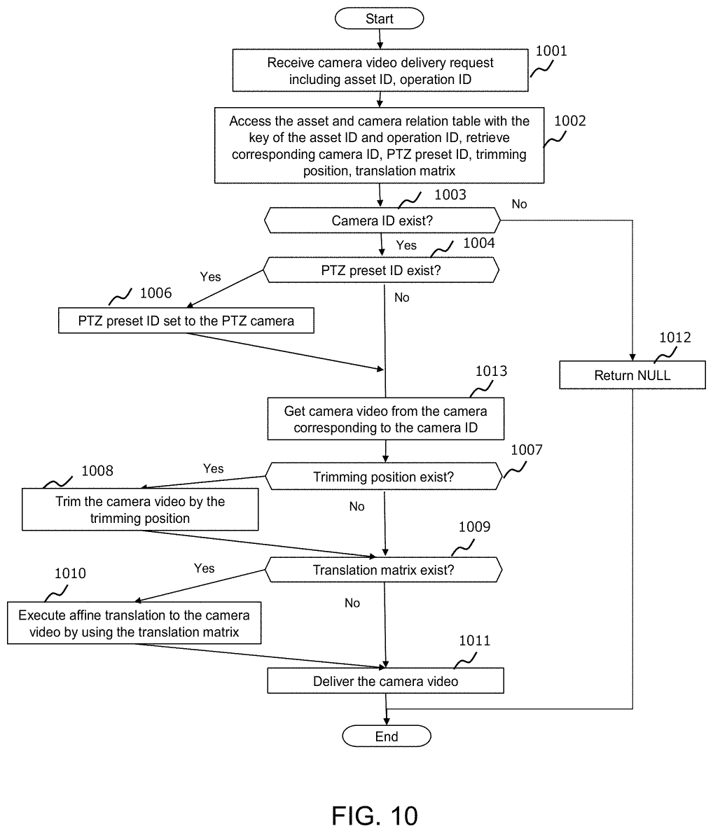

FIG. 10 illustrates an example flow diagram for a camera video delivery module 207, in accordance with an example implementation. Specifically, FIG. 10 illustrates an example flow diagram for camera video delivery module 207 for delivering the camera video corresponding to the received asset ID and operation ID. At 1001, the module 207 receives camera video delivery request including the asset ID and operation ID. At 1002, the module 207 accesses the asset and camera relation table 213 and utilizes the asset ID and operation ID as the key to retrieve corresponding camera ID, PTZ preset ID, trimming position, and translation matrix information. At 1003, the module 207 determines whether the camera ID exists. If not (No) then the flow proceeds to 1012 to return NULL, otherwise (Yes) the flow proceeds to 1004.

At 1004, the module 207 determines whether the PTZ preset ID exists. If so (Yes) then the flow proceeds to 1006, otherwise (No) the flow proceeds to 1013. At 1006, the module 207 sets the PTZ preset ID to the PTZ camera.

At 1013, the module 207 obtains camera video from the camera corresponding to the camera ID. At 1007, the module 207 determines whether the trimming position exists in the asset and camera relation table 213. If so (Yes), then the flow proceeds to 1008, wherein the module 207 trims the camera video according to the trimming position indicated in the asset and camera relation table 213. Otherwise (No) the flow proceeds to 1009. At 1009, the module 207 determines whether the translation matrix exists in the asset and camera relation table 213. If so (Yes) then the flow proceeds to 1010, otherwise (No) the flow proceeds to 1011. At 1010 the module 207 executes an affine translation operation to the camera video by using the translation matrix stored in the asset and camera relation table 213. At 1011, the module 207 delivers the camera video.

Through the first example implementation, systems and methods can not only adjust the monitored position, but can also adjust the scale and angle of the cameras for each factory asset. Such implementations can be conducted for each operation to address incidents, by having operators adjust cameras by using the assets and cameras information and updating the link between assets and cameras based on their adjustments.

### Second Example Implementation

In a second example implementation, systems and methods are configured to select a camera and deliver the camera video based on the priority of asset camera video request. If the corresponding cameras are PTZ cameras and have already been delivered by another higher-prioritized request, the substitute camera capable of showing the requested factory asset is delivered.

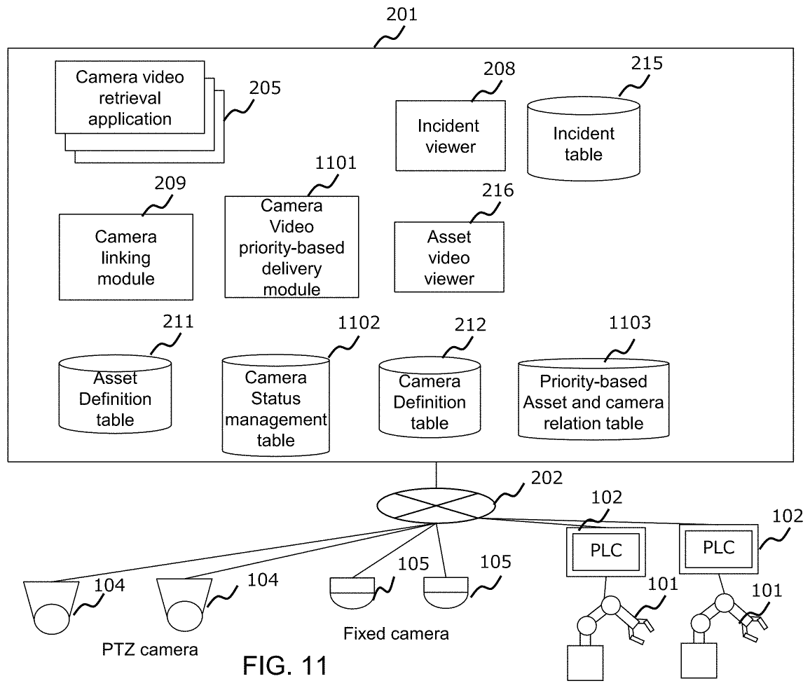

FIG. 11 illustrates another example system configuration, in accordance with an example implementation. Specifically, FIG. 11 illustrates the system configuration for facilitating the second example implementation as described above. In the second example implementation, the factory management computer 201 has camera video priority-based delivery module 1101, camera status management table 1102, priority-based asset and camera relation table 1103, in addition to camera linking module 209, incident viewer 208, asset video viewer 216, asset definition table 211, incident definition table 215, camera definition table 212, and camera video retrieval applications 205.

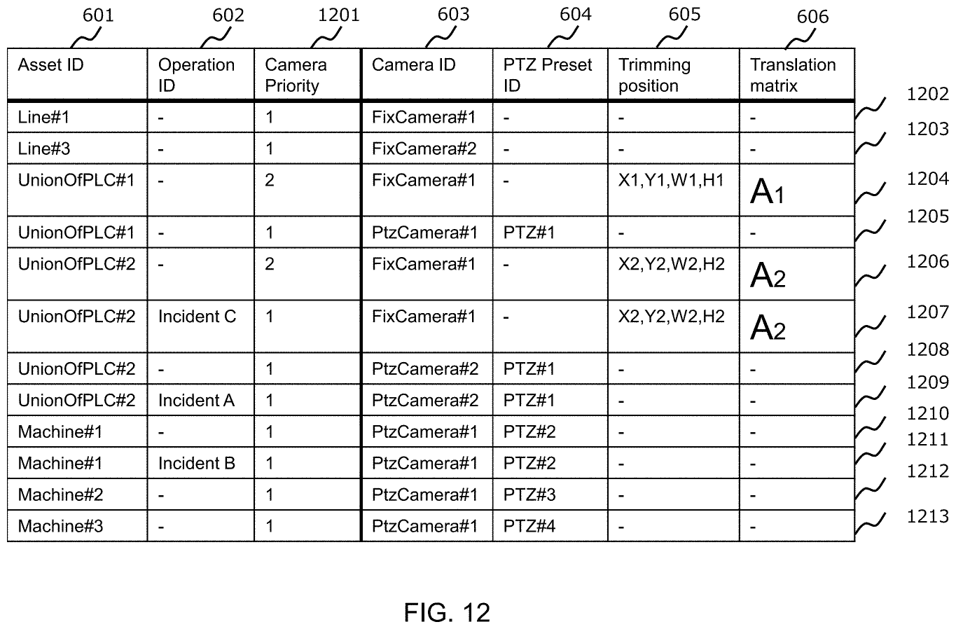

FIG. 12 illustrates a priority-based asset and camera relation table, in accordance with an example implementation. Specifically, FIG. 12 illustrates a priority-based asset and camera relation table 1103, which is based on the asset and camera relation table 213 with an addition of a camera priority column. When there are multiple rows having the same asset ID and operation ID or having the same asset ID and NULL in the operator ID, the different camera priorities are set in such rows.

When the camera video of an asset is accessed, a camera is selected according to the priority of the camera. When the higher priority cameras are used for showing other assets, the lower priority camera is selected. The data is stored when the relation is added through the camera linking module 209. The table 1103 has the following columns: camera priority 1201, in addition to asset ID 601, operation ID 602, camera ID 603, PTZ preset ID 604, trimming position 605, and translation matrix 606 in the asset and camera relation table. The asset ID 601, the incident type ID 602, the camera ID 603, the PTZ preset ID 604, the trimming position 605, and the translation matrix 606 shows the same information as the asset and camera relation table 213 of FIG. 6. The camera priority 1201 shows the priority to select the camera when the asset ID and operation ID are requested. Entries 1202-1213 serve the same functions as the entries of asset and camera relation table 213 of FIG. 6, only with information for camera priority 1201.

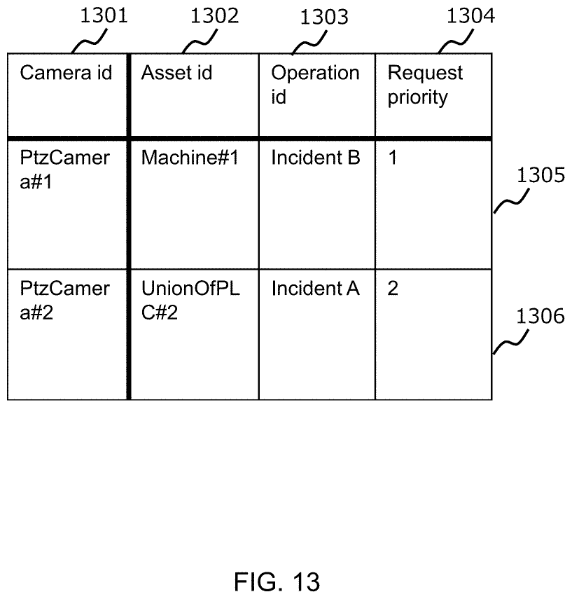

FIG. 13 illustrates a camera status management table 1102, in accordance with an example implementation. The table 1102 stores the delivery status of camera videos. The data is updated when the new deliveries of camera video are started. The table 1102 has the following columns: camera ID 1301, asset ID 1302, operation ID 1303, and request priority 1304. The camera ID 1301 shows the ID of the camera whose video is delivered. The asset ID 1302 shows the ID of the asset linked to the camera. The operation ID 1303 shows the ID of operator linked to the camera and the asset. The request priority 1304 shows the priority of the camera video request. If a request priority of a new camera video is higher than the request priority 1304, the corresponding entry row is updated to the new camera video request's asset ID, operation ID, and request priority. Entries 1305, 1306 indicate the status of a particular camera.

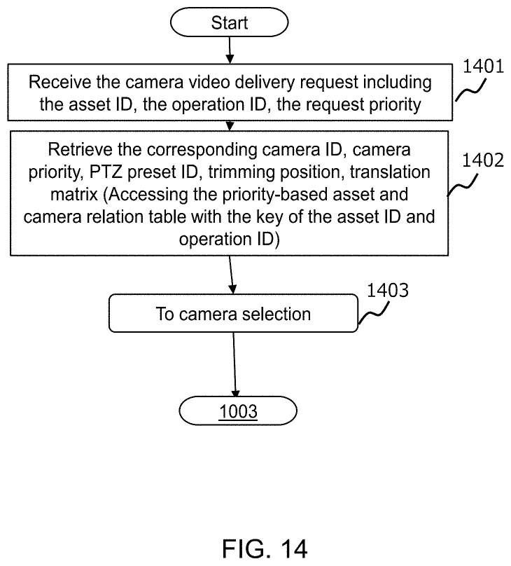

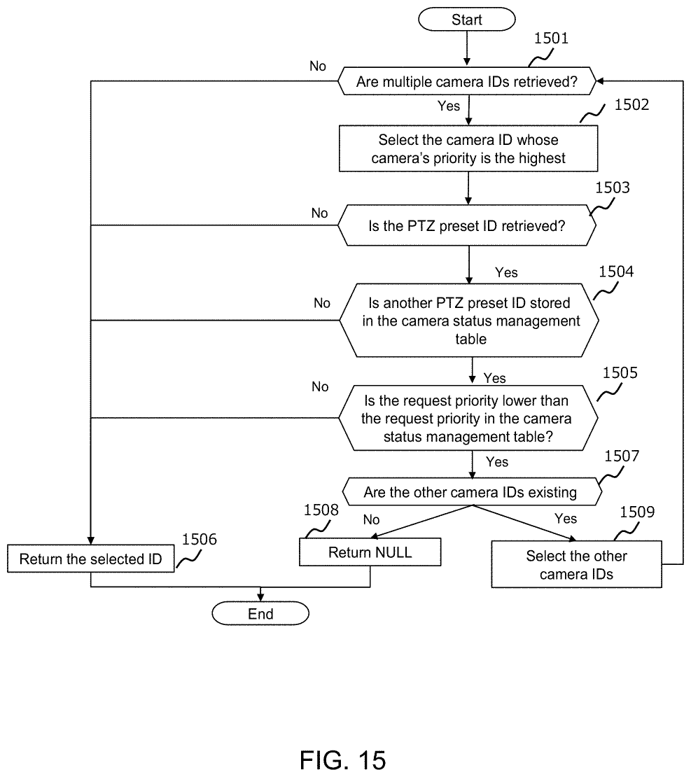

FIG. 14 illustrates an example flow chart for the camera video priority-based delivery module 1101, in accordance with an example implementation. Specifically, FIG. 14 illustrates a flow chart for delivering the camera video based on a camera video request's priority. At 1401, the module 1101 receives the camera video delivery request including the asset ID, the operation ID, and the request priority. At 1402 the module 1101 retrieves the corresponding camera ID, camera priority, PTZ preset ID, trimming position, and translation matrix through accessing the priority-based asset and camera relation table 1103 of FIG. 12 with the asset ID and operation ID used as the key for referencing the corresponding entry row. At 1403, the module 1101 moves to the camera selection operation of FIG. 15, whereupon the flow proceeds to 1003 from FIG. 10.

FIG. 15 illustrates a flow chart for the camera selection operation of the camera video priority-based delivery module 1101, in accordance with an example implementation. Specifically, FIG. 15 illustrates a flow chart of the camera selection flow of 1403 in the camera video priority-based delivery module 1101 for selecting the cameras based on the request priority, the request priorities on the camera status management table 1102, and the camera priorities on the priority-based asset and camera relation table 1103.

At 1501, the module 1101 determines whether multiple camera IDs are retrieved. If so (Yes) the flow proceeds to 1502, otherwise (No) the flow proceeds to 1506. At 1502, the module 1101 selects the camera ID having the highest camera priority. At 1503, the module 1101 determines whether the PTZ preset ID is retrieved. If so (Yes) the flow proceeds to 1504, otherwise (No) the flow proceeds to 1506. At 1504 the module 1101 determines whether another PTZ preset ID is stored in the camera status management table 1102. If so (Yes) the flow proceeds to 1505, otherwise (No) the flow proceeds to 1506. At 1505, the module 1101 determines whether the request priority is lower than the request priority in the camera status management table. If so (Yes), the flow proceeds to 1507 otherwise (No) the flow proceeds to 1506. At 1506, the module 1101 returns the selected ID.

At 1507, the module 1101 determines whether the other camera IDs exist. If so (Yes) then the flow proceeds to 1509, otherwise (No) the flow proceeds to 1508 to return NULL. At 1509, the module 1101 selects the other camera IDs.

Through the second example implementation, conflicts resulting from multiple asset access requests can be resolved.

### Third Example Implementation

In a third example implementation, asset manuals and specifications are provided with system integrators, and the factory map, locations of cameras, assets with corresponding locations, and logical hierarchy are registered.

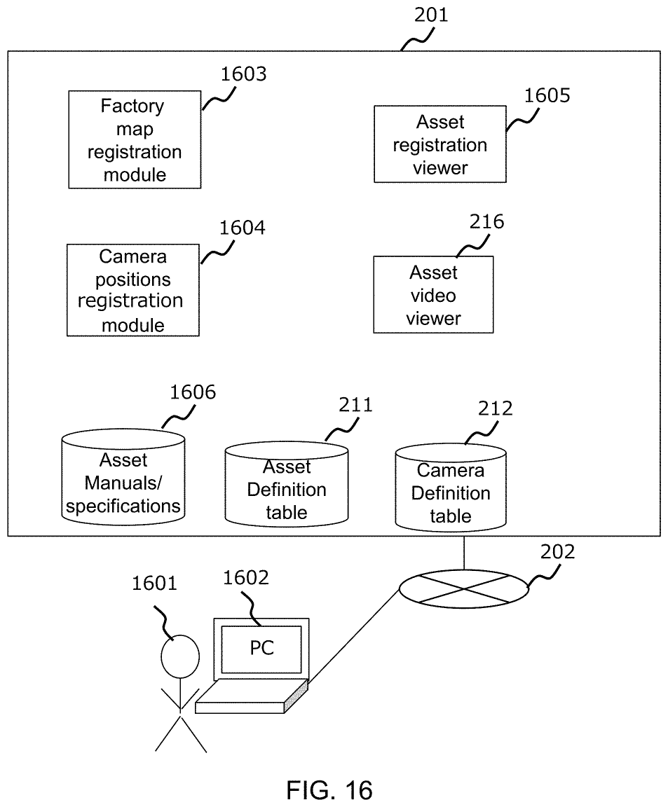

FIG. 16 illustrates an example system configuration in accordance with an example implementation. The system integrator 1601 uses the client PC 1602 that connects to the factory management computer 201. The factory management computer 201 has the factory map registration module 1603, camera position registration module 1604, the asset registration viewer 1605, the asset video viewer 216, the asset manuals and specifications 1606, the asset definition table 211, and the camera definition table 212. The factory map is input to the factory map registration module 1603 by the system integrator 1601 and uploaded to the asset registration viewer 1605 and the asset video viewer 216. The camera position data is input to the camera positions registration module 1604 by the system integrator 1601 and stored into the camera definition table 212. The asset manuals and specifications 1606 are downloaded and read by the system integrator 1601 to register asset information through the asset registration viewer 1605.

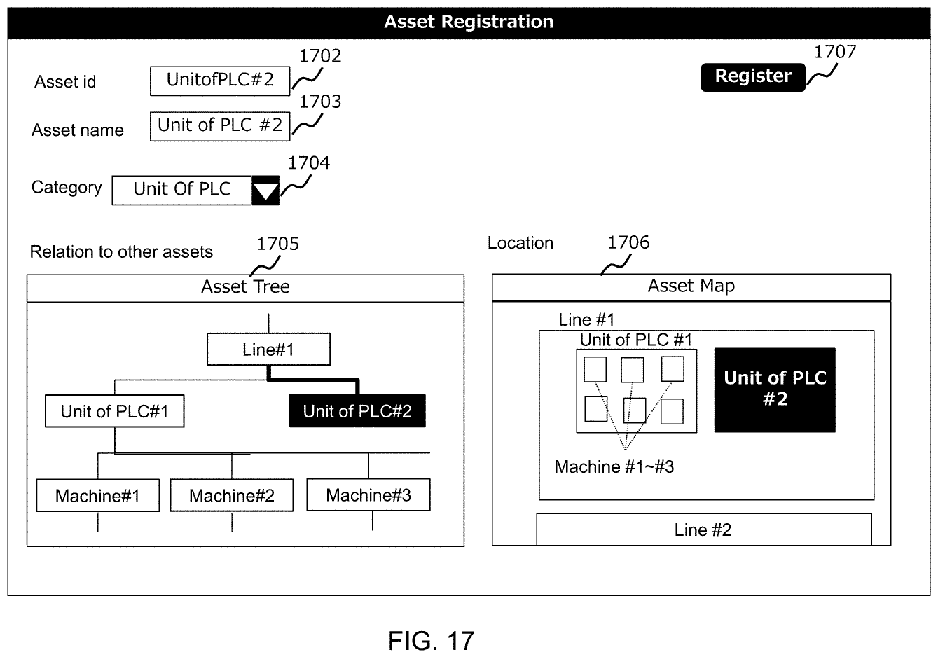

FIG. 17 illustrates an asset registration viewer, in accordance with an example implementation. Specifically, FIG. 17 illustrates the asset registration viewer 1605 for registering the asset information including the asset logical hierarchy and locations. The asset information is inputted on the asset registration viewer 1605 and the information is stored into the asset definition table 211. The asset ID 1702 and the asset name 1703 are input and the asset category 1704 is inputted or selected. The parent asset ID is input through the asset tree Graphical User Interface (GUI) 1705. The asset location is input through the asset map GUI 1706. If the “register” button 1707 is clicked or selected, all of the inputted data is stored into the asset definition table 211.

Through this example implementation, system integrators are enabled to make the asset video viewer. Example implementations are utilized to show/store/analyze camera videos in a monitoring system, anomaly detection and management system, and traceability system in factories.

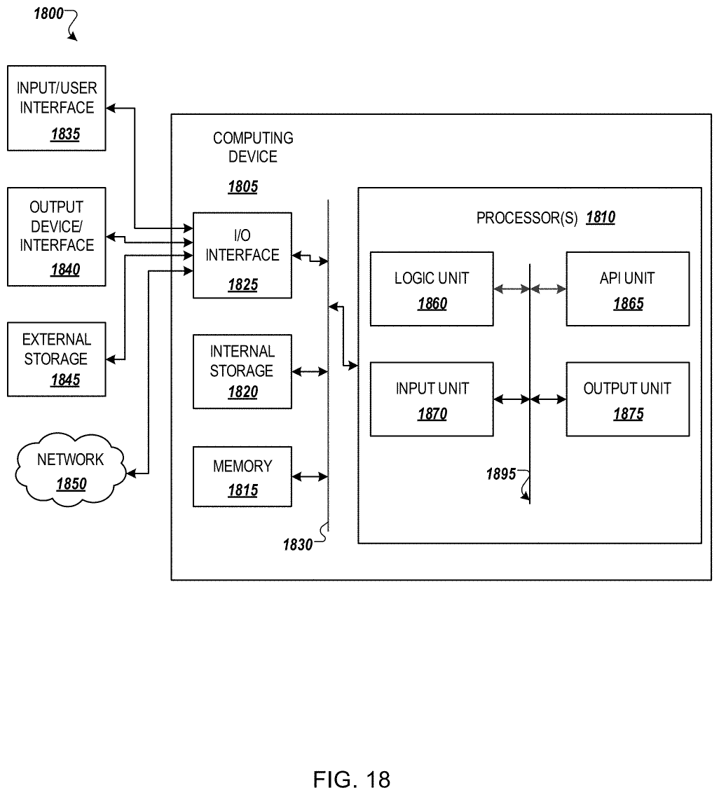

FIG. 18 illustrates an example computing environment with an example computer device suitable for use in some example implementations, such as the factory management computer system as illustrated in FIGS. 2, 11 and 16 and/or the user device 106 as illustrated in FIG. 1.

Computer device 1805 in computing environment 1800 can include one or more processing units, cores, or processors 1810, memory 1815 (e.g., RAM, ROM, and/or the like), internal storage 1820 (e.g., magnetic, optical, solid state storage, and/or organic), and/or I/O interface 1825, any of which can be coupled on a communication mechanism or bus 1830 for communicating information or embedded in the computer device 1805. I/O interface 1825 is also configured to receive images from cameras or provide images to projectors or displays, depending on the desired implementation.

Computer device 1805 can be communicatively coupled to input/user interface 1835 and output device/interface 1840. Either one or both of input/user interface 1835 and output device/interface 1840 can be a wired or wireless interface and can be detachable. Input/user interface 1835 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1840 may include a display, television, monitor, printer, speaker, braille, or the like. In some example implementations, input/user interface 1835 and output device/interface 1840 can be embedded with or physically coupled to the computer device 1805. In other example implementations, other computer devices may function as or provide the functions of input/user interface 1835 and output device/interface 1840 for a computer device 1805.

Examples of computer device 1805 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1805 can be communicatively coupled (e.g., via I/O interface 1825) to external storage 1845 and network 1850 for communicating with any number of networked components, devices, and systems, including one or more computer devices of the same or different configuration. Computer device 1805 or any connected computer device can be functioning as, providing services of, or referred to as a server, client, thin server, general machine, special-purpose machine, or another label.

I/O interface 1825 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1800. Network 1850 can be any network or combination of networks (e.g., the Internet, local area network, wide area network, a telephonic network, a cellular network, satellite network, and the like).

Computer device 1805 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1805 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1810 can execute under any operating system (OS) (not shown), in a native or virtual environment. One or more applications can be deployed that include logic unit 1860, application programming interface (API) unit 1865, input unit 1870, output unit 1875, and inter-unit communication mechanism 1895 for the different units to communicate with each other, with the OS, and with other applications (not shown). The described units and elements can be varied in design, function, configuration, or implementation and are not limited to the descriptions provided.

In some example implementations, when information or an execution instruction is received by API unit 1865, it may be communicated to one or more other units (e.g., logic unit 1860, input unit 1870, output unit 1875). In some instances, logic unit 1860 may be configured to control the information flow among the units and direct the services provided by API unit 1865, input unit 1870, output unit 1875, in some example implementations described above. For example, the flow of one or more processes or implementations may be controlled by logic unit 1860 alone or in conjunction with API unit 1865. The input unit 1870 may be configured to obtain input for the calculations described in the example implementations, and the output unit 1875 may be configured to provide output based on the calculations described in example implementations.

Memory 1815 can be configured to store management information as illustrated in FIGS. 3-6 and FIGS. 12-13 for management of the physical locations of the cameras and assets in a factory setting, as well as the incidents and operations occurring in the factory. The management information stored therein can be utilized by processor(s) 1810 for the provision of interfaces as illustrated in FIGS. 7, 8 and 17, and for facilitating the executions of the flow diagrams illustrated in FIGS. 9(a), 9(b), 10, 14, and 15.

Processor(s) 1810 can be configured to execute the flow diagrams as illustrated in FIGS. 9(a), 9(b), 10, 14 and 15 to provide video of a target asset in response to an operation. In an example implementation, processor(s) 1810 can be configured to receive a selection of one or more cameras from a plurality of cameras for the target asset from a plurality of assets, the target asset selected from a logical hierarchy arrangement of the plurality of assets, the selection of the one or more cameras based on a physical location of the one or more cameras and a physical location of the target asset, and for each of the selected one or more cameras, receive a configuration of camera scale and camera angle for the target asset from the plurality of assets and the operation, and associate the configuration for the each of the selected one or more cameras with the target asset and the operation through the interface of FIG. 8 and through the flow diagrams of FIGS. 9(a) and 9(b). For the occurrence of the operation for the target asset, processor(s) 1810 can be configured to deliver the video for the target asset in response to the operation through configuring a camera from the selected one or more cameras according to the associated configuration as illustrated in the flow diagrams of FIGS. 10, 14 and 15.

As described in example implementations, the plurality of cameras can involve at least one pan/tilt/zoom (PTZ) camera linked to the plurality of assets as illustrated in FIG. 1, wherein the configuration of the camera scale and the camera angle comprises physical PTZ configurations that are set for the delivery of the video from the at least one PTZ camera as illustrated in the management information of FIGS. 5 and 6.

As described in example implementations, the plurality of cameras can involve at least one fixed camera linked to the plurality of assets as illustrated in FIG. 1, wherein the configuration of the camera scale and the camera angle comprises trimming positions and translation matrixes, wherein video from the at least one fixed camera is trimmed according to the trimming positions and undergoes an affine translation according to the translation matrixes for the delivery of the video from the at least one fixed camera as illustrated in the management information of FIGS. 5 and 6.

In example implementations, operations can involve incidents occurring for the target asset as well as solutions/operations to the incident as illustrated in FIGS. 4 and 5.

In example implementations, processor(s) 1810 can be configured to deliver the target asset in response to the operation through configuring a camera from the selected one or more cameras according to the associated configuration by selecting the camera from the selected one or more cameras for delivering the video based on a priority associated with the operation; for the camera being a PTZ camera in a process of delivering video for another operation having a higher priority, selecting a different camera from the each of the selected one or more cameras for delivering the video, configuring the different camera according to the associated configuration, and delivering the video from the different camera; and for the camera being otherwise available for delivering video, configuring the camera according to the associated configuration, and delivering the video from the camera as illustrated in FIGS. 10, 14 and 15.

In example implementations, processor(s) 1810 can be configured to provide an interface for inputting the logical hierarchy arrangement of the plurality of assets, the physical location of the one or more cameras and the physical location of the target asset as incorporated from asset manuals and specifications as illustrated in the interface of FIG. 17.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

1. A method for providing video of a target asset in response to an operation, the method comprising:
receiving a selection of one or more cameras from a plurality of cameras for the target asset from a plurality of assets, the target asset selected from a logical hierarchy arrangement of the plurality of assets, the selection of the one or more cameras based on a physical location of the one or more cameras and a physical location of the target asset;
for each of the selected one or more cameras, receiving a configuration of camera scale and camera angle for the target asset from the plurality of assets and the operation;
associating the configuration for the each of the selected one or more cameras with the target asset and the operation; and
for an occurrence of the operation for the target asset, delivering the video of the target asset in response to the operation through configuring a camera from the selected one or more cameras according to the associated configuration of the camera scale and the camera angle.

2. The method according to claim 1, wherein the plurality of cameras comprises at least one pan/tilt/zoom (PTZ) camera linked to the plurality of assets, wherein the configuration of the camera scale and the camera angle comprises physical PTZ configurations that are set for the delivery of the video from the at least one PTZ camera.

3. The method according to claim 1, wherein the plurality of cameras comprises at least one fixed camera linked to the plurality of assets, wherein the configuration of the camera scale and the camera angle comprises trimming positions and translation matrixes, wherein video from the at least one fixed camera is trimmed according to the trimming positions and undergoes an affine translation according to the translation matrixes for the delivery of the video from the at least one fixed camera.

4. The method according to claim 1, wherein the operation comprises at least one of an incident occurring for the target asset, and a solution to the incident.

5. The method according to claim 1, wherein the delivering the video for the target asset in response to the operation through configuring the camera from the selected one or more cameras according to the associated configuration comprises:
selecting the camera from the selected one or more cameras for delivering the video based on a priority associated with the operation;
for the camera being a PTZ camera in a process of delivering video for another operation having a higher priority, selecting a different camera from the each of the selected one or more cameras for delivering the video, configuring the different camera according to the associated configuration, and delivering the video from the different camera;
for the camera being otherwise available for delivering video, configuring the camera according to the associated configuration, and delivering the video from the camera.

6. The method according to claim 1, wherein the logical hierarchy arrangement of the plurality of assets, the physical location of the one or more cameras and the physical location of the target asset are incorporated from asset manuals and specifications.

7. A non-transitory computer readable medium, storing instructions for providing video of a target asset in response to an operation, the instructions comprising:
receiving a selection of one or more cameras from a plurality of cameras for the target asset from a plurality of assets, the target asset selected from a logical hierarchy arrangement of the plurality of assets, the selection of the one or more cameras based on a physical location of the one or more cameras and a physical location of the target asset;
for each of the selected one or more cameras, receiving a configuration of camera scale and camera angle for the target asset from the plurality of assets and the operation;
associating the configuration for the each of the selected one or more cameras with the target asset and the operation; and
for an occurrence of the operation for the target asset, delivering the video of the target asset in response to the operation through configuring a camera from the selected one or more cameras according to the associated configuration of the camera scale and the camera angle.

8. The non-transitory computer readable medium according to claim 7, wherein the plurality of cameras comprises at least one pan/tilt/zoom (PTZ) camera linked to the plurality of assets, wherein the configuration of the camera scale and the camera angle comprises physical PTZ configurations that are set for the delivery of the video from the at least one PTZ camera.

9. The non-transitory computer readable medium according to claim 7, wherein the plurality of cameras comprises at least one fixed camera linked to the plurality of assets, wherein the configuration of the camera scale and the camera angle comprises trimming positions and translation matrixes, wherein video from the at least one fixed camera is trimmed according to the trimming positions and undergoes an affine translation according to the translation matrixes for the delivery of the video from the at least one fixed camera.

10. The non-transitory computer readable medium according to claim 7, wherein the operation comprises at least one of an incident occurring for the target asset, and a solution to the incident.

11. The non-transitory computer readable medium according to claim 7, wherein the delivering the video for the target asset in response to the operation through configuring the camera from the selected one or more cameras according to the associated configuration comprises:
selecting the camera from the selected one or more cameras for delivering the video based on a priority associated with the operation;
for the camera being a PTZ camera in a process of delivering video for another operation having a higher priority, selecting a different camera from the each of the selected one or more cameras for delivering the video, configuring the different camera according to the associated configuration, and delivering the video from the different camera;
for the camera being otherwise available for delivering video, configuring the camera according to the associated configuration, and delivering the video from the camera.

12. The non-transitory computer readable medium according to claim 7, wherein the logical hierarchy arrangement of the plurality of assets, the physical location of the one or more cameras and the physical location of the target asset are incorporated from asset manuals and specifications.

13. A system for providing video of a target asset in response to an operation, the system comprising:
a plurality of cameras; and
a processor, configured to:
receive a selection of one or more cameras from the plurality of cameras for a target asset from a plurality of assets, the target asset selected from a logical hierarchy arrangement of the plurality of assets, the selection of the one or more cameras based on a physical location of the one or more cameras and a physical location of the target asset;
for each of the selected one or more cameras, receive a configuration of camera scale and camera angle for the target asset from the plurality of assets and the operation;
associate the configuration for the each of the selected one or more cameras with the target asset and the operation; and
for an occurrence of the operation for the target asset, deliver the video of the target asset in response to the operation through configuring a camera from the selected one or more cameras according to the associated configuration of the camera scale and the camera angle.

14. The system according to claim 13, wherein the plurality of cameras comprises at least one pan/tilt/zoom (PTZ) camera linked to the plurality of assets, wherein the configuration of the camera scale and the camera angle comprises physical PTZ configurations that are set for the delivery of the video from the at least one PTZ camera.

15. The system according to claim 13, wherein the plurality of cameras comprises at least one fixed camera linked to the plurality of assets, wherein the configuration of the camera scale and the camera angle comprises trimming positions and translation matrixes, wherein video from the at least one fixed camera is trimmed according to the trimming positions and undergoes an affine translation according to the translation matrixes for the delivery of the video from the at least one fixed camera.

16. The system according to claim 13, wherein the operation comprises at least one of an incident occurring for the target asset, and a solution to the incident.

17. The system according to claim 13, wherein the processor is configured to deliver the video for the target asset in response to the operation through configuring the camera from the selected one or more cameras according to the associated configuration by:
selecting the camera from the selected one or more cameras for delivering the video based on a priority associated with the operation;
for the camera being a PTZ camera in a process of delivering video for another operation having a higher priority, selecting a different camera from the each of the selected one or more cameras for delivering the video, configuring the different camera according to the associated configuration, and delivering the video from the different camera;
for the camera being otherwise available for delivering video, configuring the camera according to the associated configuration, and delivering the video from the camera.

18. The system according to claim 13, wherein the logical hierarchy arrangement of the plurality of assets, the physical location of the one or more cameras and the physical location of the target asset are incorporated from asset manuals and specifications.
